(19) United States
(12) Patent Application Publication
(10) Pub. No.: US 2009/0164386 A1
(43) Pub. Date: Jun. 25, 2009

(54) METHOD AND SYSTEM FOR STANDARDIZED REPORTING OF FAILED TRADES

(75) Inventors: Steven Greenfield, New York, NY (US); Robert Eugene Tjia, Danbury, CT (US)

Correspondence Address: MESCHKOW & GRESHAM, P.L.C., 5727 NORTH SEVENTH STREET, SUITE 409, PHOENIX, AZ, 85014, US

(73) Assignee: Middle Office Solutions, L.L.C, New York, NY (US)

(21) Appl. No.: 12/333,672

(22) Filed: Dec. 12, 2008

Related U.S. Application Data
(60) Provisional application No. 61/015,319, filed on Dec. 20, 2007.

(51) Int. Cl. G06Q 40/00

(52) U.S. Cl. 705/36 R

(57) ABSTRACT

A computer-based method for standardized reporting of failed trades entails receiving trade data from a data generator, the trade data including information characterizing at least one failed trade. A current format (e.g., XML format, SWIFT message format, spreadsheet format) for the trade data is identified and a conversion template is selected for the current format. The received trade data is converted into at least one failed trade record having a standardized format using the conversion template, and is stored in a failed trades database. A trade fail report that includes at least one failed trade record is generated by accessing failed trade records in the failed trades database. The trade fail report can then be provided to an authorized data consumer.

### RELATED INVENTIONS

The present invention claims priority under 35 U.S.C. §119(e) to: “An Internet-based Multi-customer Trade Reporting System, Apparatus, and Method,” U.S. Provisional Patent Application Ser. No. 61/015,319, filed 20 Dec. 2008, which is incorporated by reference herein.

### TECHNICAL FIELD OF THE INVENTION

The present invention relates generally to the post-trade settlement process. More specifically, the present invention relates to a method and system for the standardized reporting of failed trades.

### BACKGROUND OF THE INVENTION

In the financial industry, investment managers manage the assets of their clients, including buying and selling financial instruments on their clients' behalf. A financial instrument refers to a real or virtual document representing a legal agreement involving some sort of monetary value. In today's financial marketplace, financial instruments can be classified generally as equity based, representing ownership of the asset, or debt based, representing a loan made by an investor to the owner of the asset.

An investment manager typically uses the services of broker-dealers to execute trades, also referred to as transactions. A broker-dealer is a person or company that buys and sells financial instruments on its own behalf or on behalf of its clients. A trade involves the buying, holding, selling, and short-selling of financial instruments such as stocks, bonds, commodities, currencies, derivatives, securities, or any other valuable financial instruments. The object of a trade is to profit from fluctuations in the price of the financial instrument, as opposed to buying it for use or for income.

The assets of the investment managers' clients are typically held in accounts located in custodian banks. In finance, a custodian bank, or simply a custodian, refers to a financial institution responsible for safeguarding a firm's or an individual's financial assets. Clients can use the custodians of their choice. As such, investment managers typically have relationships with many broker-dealers and many custodian banks.

When an investment manager makes a trade on behalf of its client, both the broker-dealer who executes the trade and the custodian who holds the client's assets will have a record of this trade in their computer systems. These records are stored in the proprietary formats of the investment manager's and the broker-dealer's computer systems.

After a trade is made, arrangements are made to settle the trade, i.e., to actually effectuate the transfer of the financial instrument to the buyer. The post-trade settlement process may also include independent third parties such as escrow agents and custodians, who hold the property or payment of one party in anticipation of the future transfer of financial instruments. However, there is always a risk to the parties that the trade may never actually settle.

The number of parties and exchanges involved complicates the post-trade settlement process, lengthening settlement times and consequently increasing the risk to parties of settlement failure. To minimize this risk, markets have attempted to standardize a deadline for completion of the settlement procedures to within a set number of days from the trade date. In the United States, the Securities and Exchange Commission which regulates transactions involving the transfer of securities has mandated that trades must be settled within three business days after the date the trade is made. However, a trade may still fail to settle within this three day period, and this may happen for a variety of reasons.

Prior to settlement, trades that will potentially fail to settle are usually known by the broker-dealers and/or the custodians involved because the settlement agency attempts to pre-match trades prior to settlement. This process flags potential settlement failures and this information is sent back to the broker-dealers and the custodians.

It is important that information on trades that fail to pre-match or trades that fail to settle be communicated to the investment managers in a timely manner. Receipt of this information will allow the investment managers to take the corrective actions necessary to remedy the situation. There are several factors that currently hinder this process for the investment managers.

A factor that hinders communication of failed pre-match and failed trades is that the trade fail data generated by broker-dealers and custodians is not standardized and comes in several formats, e.g., spreadsheets, plain text, verbally, etc. In addition, delivery mechanisms for communicating trade fail reports are inconsistent. For example, trade fail reports can be communicated via a web page, e-mail, telephone, etc. Furthermore, non-standard data field names and non-standard field contents are used across the different trade fail reports. Accordingly, investment managers cannot get a consolidated, standardized view of failed trade reports across multiple broker-dealers and/or custodians. In order to do so, the investment managers are compelled to consolidate the various reports, which takes time and is prone to error. Accordingly, what is needed is a method and system for the standardized reporting of failed trades.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram of a failed trade reporting system in accordance with an embodiment of the invention;

FIG. 2 shows a table of failed trade records stored in a standardized format in a failed trades database of the failed trade reporting system;

FIG. 3 shows a block diagram exemplifying input mechanisms for receiving trade data at the failed trade reporting system;

FIG. 4 shows a flowchart exemplifying a web service feed process executed in accordance with the failed trade reporting system;

FIG. 5 shows a flowchart of a receive subprocess of the web service feed process;

FIG. 6 shows a document of trade data that may be sent to a web server component of the failed trades reporting system;

FIG. 7 shows a flowchart of a processing subprocess of the web service feed process;

FIG. 8 shows a flowchart of a provider site SWIFT message management process executed in accordance with the failed trade reporting system;

FIG. 9 shows a flowchart of a SWIFT message feed process executed in accordance with the failed trade reporting system;

FIG. 10 shows a flowchart of an e-mail spreadsheet feed process executed in accordance with the failed trade reporting system;

FIG. 11 shows a flowchart of an FTP spreadsheet feed process executed in accordance with the failed trade reporting system;

FIG. 12 shows a flowchart of a website spreadsheet feed process executed in accordance with the failed trade reporting system;

FIG. 13 shows a flowchart of a data conversion process executed in accordance with the failed trade reporting system;

FIG. 14 shows a table of exemplary fields of trade data in an XML format and converted trade data in a standardized format resulting from the execution of the data conversion process of FIG. 13;

FIG. 15 shows a flowchart of a trade report generation process executed in accordance with the failed trade reporting system; and

FIG. 16 shows a table of an exemplary trade fail report generated in response to the execution of the trade report generation process of FIG. 15.

### DETAILED DESCRIPTION

Embodiments of the invention include a computer-based method and a failed trades reporting system for accepting data regarding failed trades and providing that data in a standardized format to subscribing customers, e.g., investment managers, broker-dealers, and custodians. In general, the methodology and system entail an Internet-based hosted service that allows broker-dealers and custodians to report failed trades to investment managers through standard interfaces. Investment managers, broker-dealers, and custodians who have Internet connectivity may be subscribing customers to the failed trades reporting system. The system and methodology utilize a common, scalable, and shared architecture that allows new subscribing customers to be added on an ongoing basis without the need for significant hardware, networking, and/or configuration changes. Embodiments of the invention provide strong logical data isolation between the various subscribing customers to prevent accidental access of another customer's data in the event of system glitches or hacking attempts. Moreover, the failed trades reporting system and methodology can accept data from various broker-dealers and custodians in various forms. Then the data is translated and stored in a standardized format that is uniform and consistent. In addition, the system and methodology allow customers to query and generate flexible failed trade reports based on various filters, sorting criteria, and thresholds.

The following is a glossary of terminology used herein:

Subscribing customers—are investment managers, broker-dealers, and custodians who have Internet connectivity and are authorized to access the failed trades reporting system. A subscribing customer can have the roll of a data generator and/or a data consumer.

Data Generator (DG)—is a broker-dealer or custodian who feeds trade data into the failed trades reporting system. Each trade record within the trade data that a data generator feeds into the failed trades reporting system is destined for a single data consumer and only that data consumer has access to the trade record.

Data Consumer (DC)—is an investment manager who queries the trade data fed into the failed trades reporting system in order to generate trade fail reports. A data consumer typically has many data generators sending data to them.

DG ID—is a data generator identifier that uniquely identifiers a data generator

DC ID—is a data consumer identifier that uniquely identifiers a data consumer

Note: data generators may also access the failed trades reporting system as pseudo data consumers. However, they can only see the trade records that they fed in. They may also have access to certain annotations/communications associated with the record that may have been added by a data consumer.

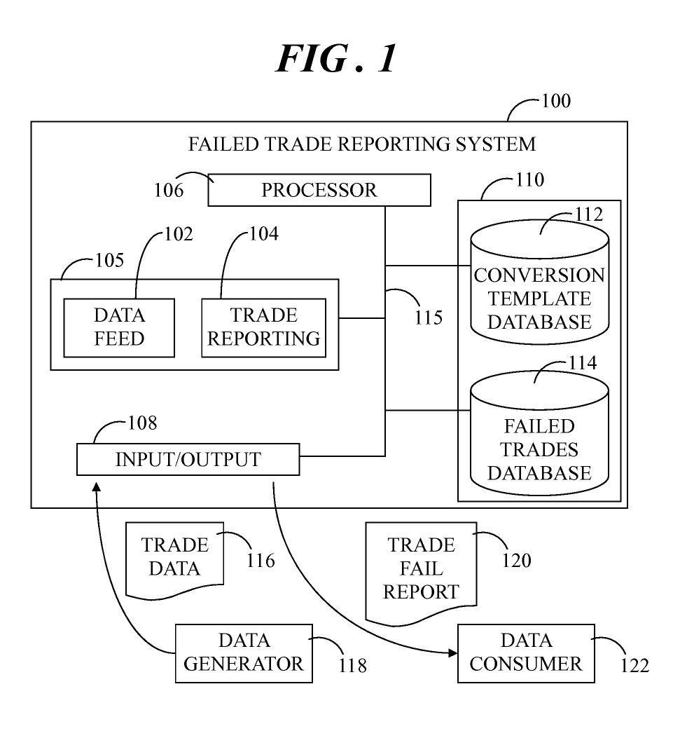

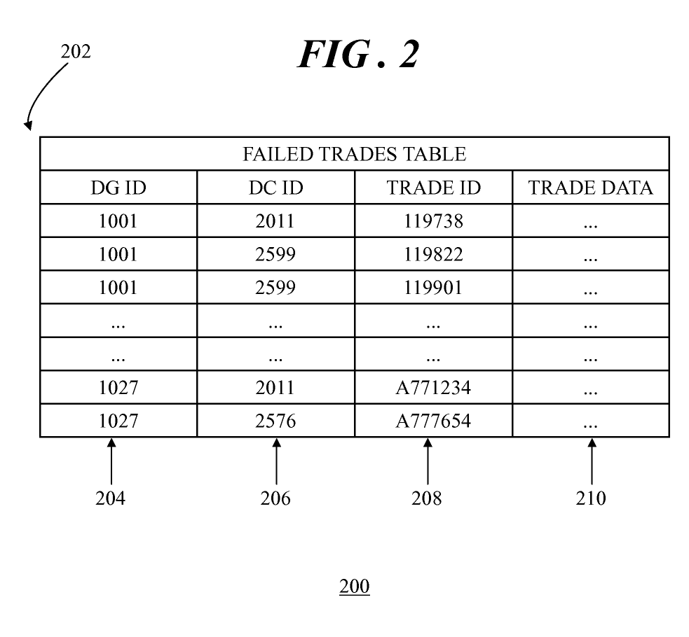

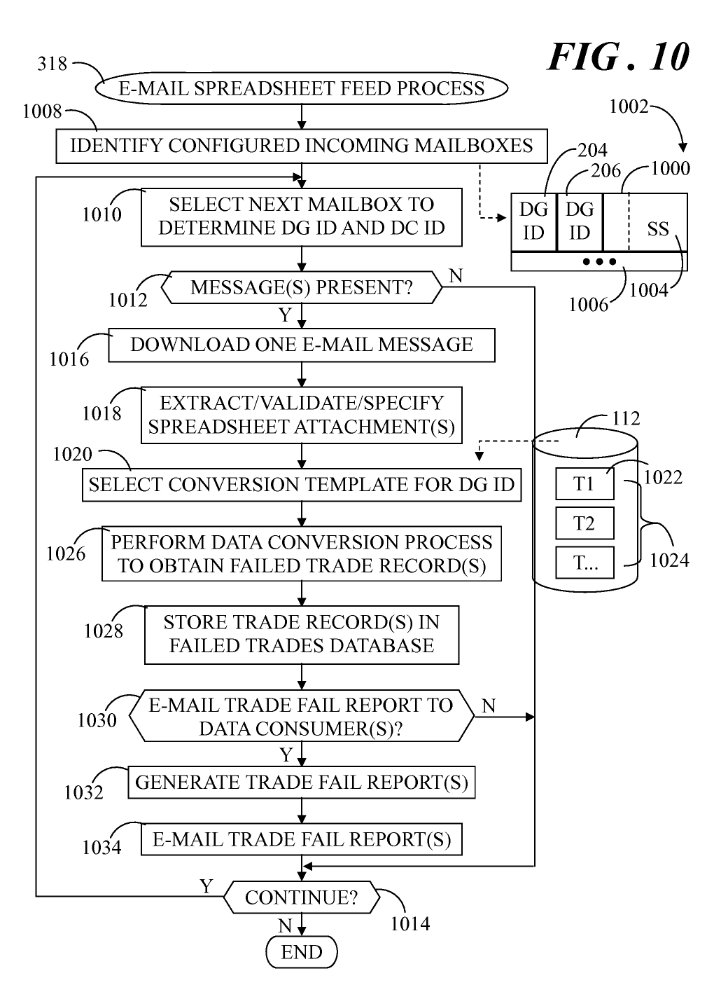

Throughout this discussion, items are assigned three- or four-digit reference numbers whose first digit or first two digits reflects the Figure in which the item first appears. That is, items first appearing in FIG. 1 are assigned reference numbers between 100 and 199, items first appearing in FIG. 2 are assigned reference numbers between 200 and 299, items first appearing in FIG. 10 are assigned reference numbers between 1000 and 1099, etc. Once assigned, a given reference number is used in all Figures in which that item appears.

### FIG. 1

FIG. 1 shows a block diagram of a failed trade reporting system 100 in accordance with an embodiment of the invention. System 100 is a computing system configured to execute a computer program in the form of a data feed system 102 and a trade reporting system 104 recorded on a computer-readable storage medium 105. System 100 includes a processor 106 on which the methods according to the invention can be practiced. Processor 106 is in communication with computer-readable storage medium 105, input/output devices 108, and a memory system 110 for storing a conversion template database 112 and a failed trades database 114, both of which are utilized in connection with the execution of data feed system 102 and trade reporting system 102. These elements may be interconnected by a bus structure 115.

Input components of input/output devices 108 can encompass a keyboard, mouse, pointing device, audio device (e.g., a microphone), and/or any other device providing input to processor 106. Of particular interest for input into failed trade reporting system 100 is trade data 116 received from a data generator 118, e.g., broker-dealer or custodian, as discussed in detail below. Trade data 116 may be detailed information regarding one or more failed trades, or failed transactions. In accordance with an embodiment, a failed trade is a trade that failed to pre-match or a trade that failed to settle within a pre-determined deadline for completion of the settlement procedures. Trade data 116 can be received in one of various formats. These formats can include extensible markup language (XML) format, Society for Worldwide Interbank Financial Telecommunication (SWIFT) message format, spreadsheet format, and the like.

Output components of input/output devices 108 can encompass a display, a printer, an audio device (e.g., a speaker), and/or other devices providing output from processor 106. Of particular interest for output from failed trade reporting system 100 is a trade fail report 120 which is provided to a data consumer 122, e.g., investment manager, as discussed in detail below. Trade fail report 120 is a compilation of failed trade records (discussed below) that is intended for provision to an authorized data consumer 122 and is provided in a standardized format. Input and output devices 108 can also include network connections, modems, or other devices used for communications with other computer systems or devices.

Computer-readable storage medium 105 may be a magnetic disk, compact disk, or any other volatile or non-volatile mass storage system readable by processor 106. Computer-readable storage medium 105 may also include cooperating or interconnected computer readable media, which exist exclusively on system 100 or are distributed among multiple interconnected computing systems (not shown) that may be local or remote.

Data feed system 102, recorded on computer-readable storage medium 105, instructs processor 106 to receive trade data 116 in one of various formats, to convert trade data 116 into one or more failed trade records having a standardized format, and to store the failed trade records in failed trades database 114. Trade reporting system 104, also recorded on computer-readable storage medium 105, instructs processor 106 to access failed trade database 114 and generate trade failed report 120 for provision to data consumer 122.

### FIG. 2

FIG. 2 shows an exemplary table 200 of failed trade records 202 stored in a standardized format in failed trades database 114 of failed trade reporting system 100. In general, execution of data feed system 102 produces table 200 of trade records 202 that is stored in failed trades database 114.

In this exemplary scenario, each of failed trade records 202 includes a data generator identifier (DG ID) 204, a data consumer identifier (DC ID) 206, a trade identifier (TRADE ID) 208, and trade related data 210. Data generator identifier 204 uniquely identifies the sending data generator 118. One of trade records 202 can only be updated by a user of the identified data generator 118. Data consumer identifier 206 uniquely identifies the receiving data consumer 122. One of trade records 202 can only be viewed by a user of the identified data consumer 122. Trade identifier 208 uniquely identifies a particular trade, or transaction. Trade related data 210 can include, for example, company, account number, country code, trade data, settle data, and other pertinent data (discussed below) that is converted to a standardized format, as discussed below.

Trade records 202 in table 200 are accessed in response to execution of trade reporting system 104 to form trade fail report 120. For example, a subset of trade records 202 designated for a particular one of data consumers 122, identified by data consumer identifier 206, may be assembled and provided to data consumer 122. Table 200 is provided for illustrative purposes. Those skilled in the art will understand that the information shown in table 200 can take various forms.

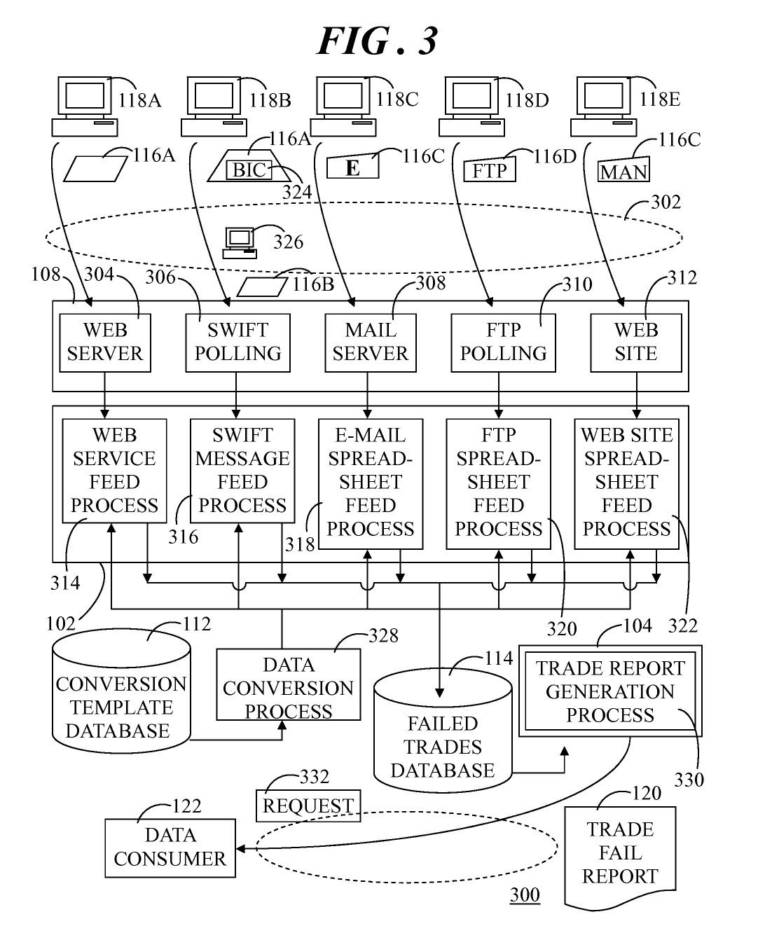

### FIG. 3

FIG. 3 shows a block diagram 300 exemplifying input mechanisms for receiving trade data 116 at failed trade reporting system 100. As mentioned above, system 100 is configured to receive trade data 116 in a number of formats from data generators 118. For clarity of discussion, a data generator 118A provides trade data 116A in an XML format. A data generator 118B provides trade data 116B in a SWIFT message format, modified to an XML format. Each of data generators 118C, 118D, and 118E provides corresponding trade data 116C, 116D, and 116E in a spreadsheet format. However, the path by which trade data 116C, 116D, and 116E is received at failed trade reporting system 100 differs.

A dashed oval 302 interposed between data generators 118A, 118B, 118C, 118D, and 118E represents the various communication paths by which trade data 116A, 116B, 116C, 116D, and 116E is received at failed trade reporting system 100. In general, trade data 116A, 116B, 116C, 116D, and 116E may be received through a secure web service, through a SWIFT messaging service, an e-mail messaging service, secure file transport protocol (FTP) service, or various methods of uploading spreadsheets.

Input/output devices 108 include the hardware and software components necessary to receive trade data 116A, 116B, 116C, 116D, and 116E. Thus, input/output devices 108 includes a web server component 304, a SWIFT polling component 306, a mail server component 308, an FTP polling component 310, and a website component 312. In addition, data feed system 102 includes code executable by processor 106 in the form of a web service feed process 314, a SWIFT message feed process 316, an e-mail spreadsheet feed service 318, an FTP spreadsheet feed process 320, and a website spreadsheet feed process 322.

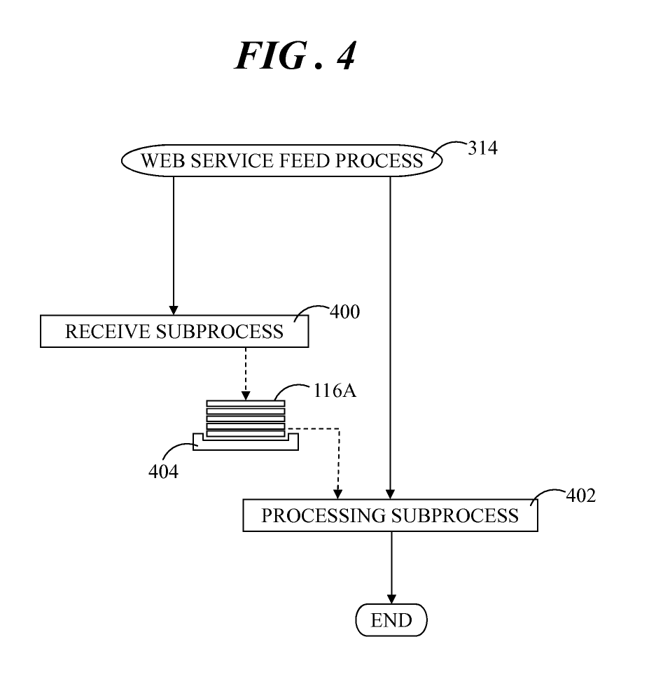

In an embodiment, data generator 118A provides trade data 116A over the Internet. Thus, web server component 304 at system 100 receives trade data 116A. In response to the receipt of trade data 116A at web server component 304, web service feed process 314 is executed to convert trade data 116A into a standardized format. Web service feed process 314 will be discussed in connection with FIGS. 4-7.

Data generator 118B provides trade data 116B via SWIFT messaging. The Society for Worldwide Interbank Financial Telecommunication (SWIFT) provides a network to allow financial and non-financial institutions to transfer financial transactions through a “financial message,” known as a SWIFT message. SWIFT standards, a division of SWIFT, handles the registration of Bank Identifier Codes (BICs). For this reason, Bank Identifier Codes (BICs) are often called SWIFT addresses or codes. A BIC is a unique identification code for a particular bank. BIC codes are used when transferring money between banks, particularly for international wire transfers, and also for the exchange of other messages between banks. A SWIFT message will include a BIC code.

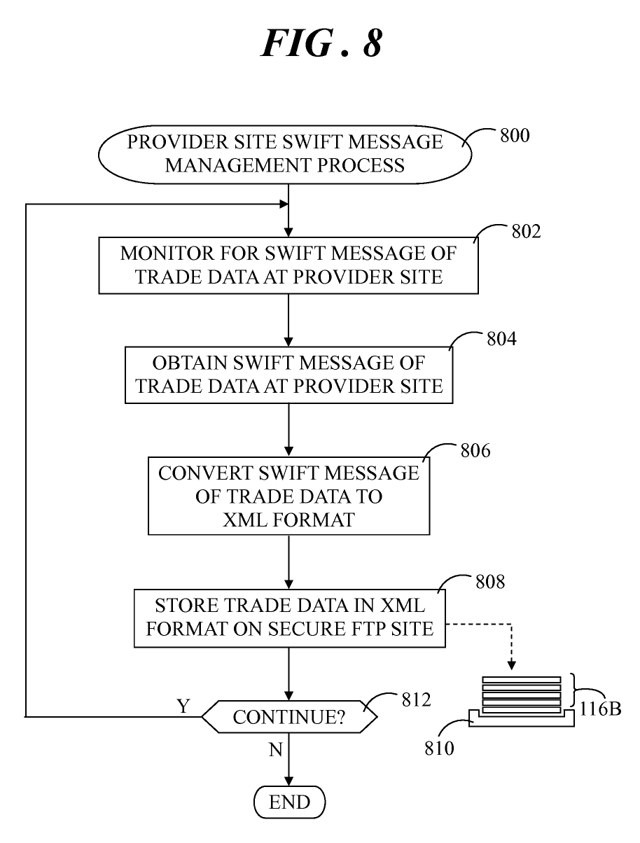

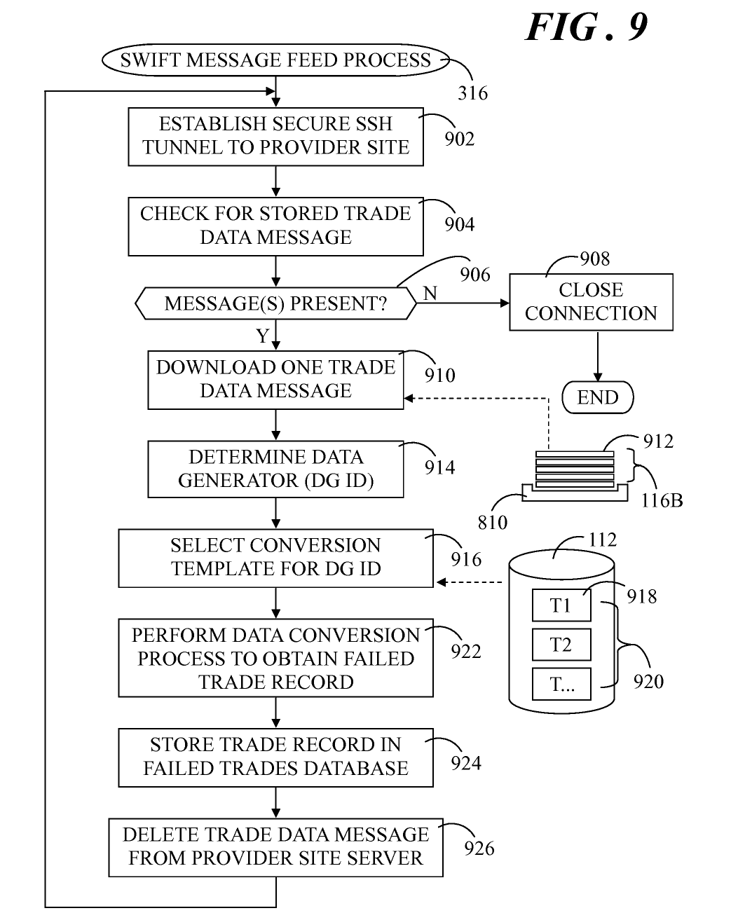

In an embodiment, data generator 118B sends SWIFT message trade data 116B via the SWIFT network to failed trade reporting system 100 by addressing a SWIFT message trade data 116B to a bank identifier code (BIC) 324 for system 100. Failed trade reporting system 100 receives SWIFT message trade data 116B via a third party provider 326 that is on the SWIFT network. However, third party provider 326 first converts SWIFT message trade data 116 into an XML format before it is received at failed trade reporting system 100. Thus, SWIFT polling component 306 at system 100 receives trade data 116B in XML format. In response to the receipt of trade data 116B at SWIFT polling component 306, SWIFT message feed process 316 is executed to convert trade data 116B into a standardized format. SWIFT message feed process 316 will be discussed in connection with FIGS. 8 and 9.

In the financial industry, some data generators 118 (broker-dealers and custodians) have in-house systems that report trade data 116 in the form of spreadsheets, such as Microsoft Excel spreadsheets. Microsoft Excel is a proprietary spreadsheet-application written and distributed by Microsoft. These spreadsheets are intended for data consumers 122 (investment managers) who are clients of the data generators 118. Many of these in-house systems can be readily configured to automatically send these spreadsheets to one or more e-mail addresses and some data consumers 122 are already automatically receiving these spreadsheets in their e-mail. Failed trade reporting system 100 can be enabled to receive these automatically sent e-mails. In an embodiment, data generator 118C provides trade data 116C as an e-mailed spreadsheet which is received at mail server component 308. In response to the receipt of e-mailed spreadsheet of trade data 116C at mail server component 308, e-mail spreadsheet feed process 318 is executed to convert e-mailed spreadsheet of trade data 116C into a standardized format. E-mail spreadsheet feed process 318 will be discussed in connection with FIG. 10.

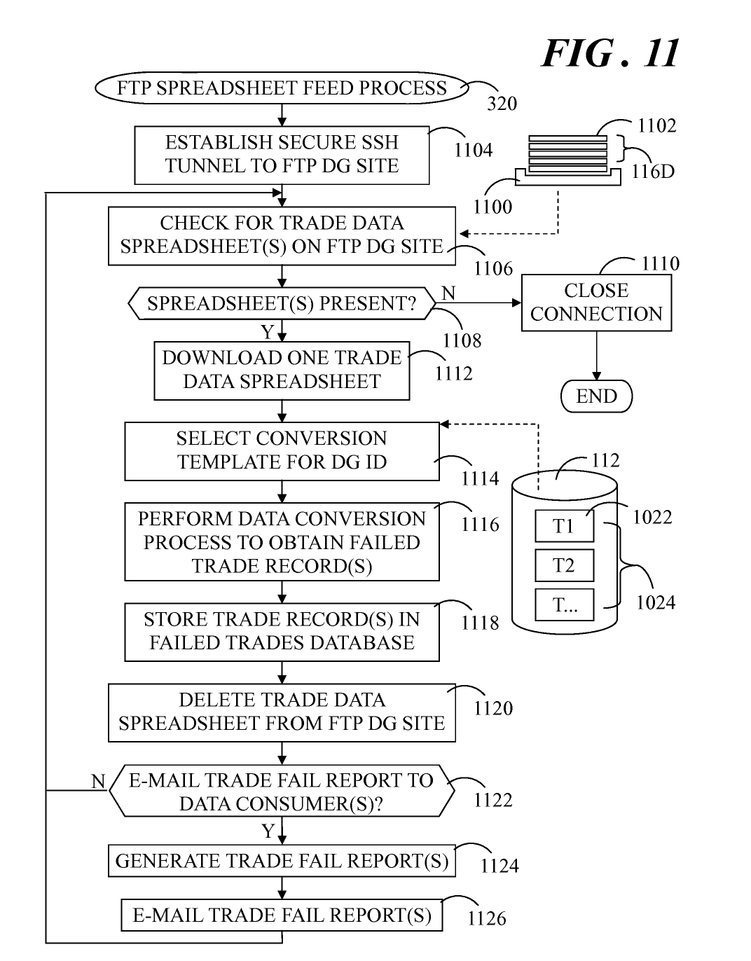

In another embodiment, data generator 118 may wish to provide spreadsheets via a secure file transfer protocol (FTP) site that is provided by data generator 118, rather than by sending the spreadsheets via e-mail. In such a scenario, data generator 118D provides trade data 116D as a spreadsheet via an FTP site, which can subsequently be received in accordance with FTP polling component 310 of failed trade reporting system 100. In response to the receipt of spreadsheet of trade data 116D, FTP spreadsheet feed process 320 is executed to convert spreadsheet of trade data 116D into a standardized format. FTP spreadsheet feed process 320 will be discussed in connection with FIG. 11.

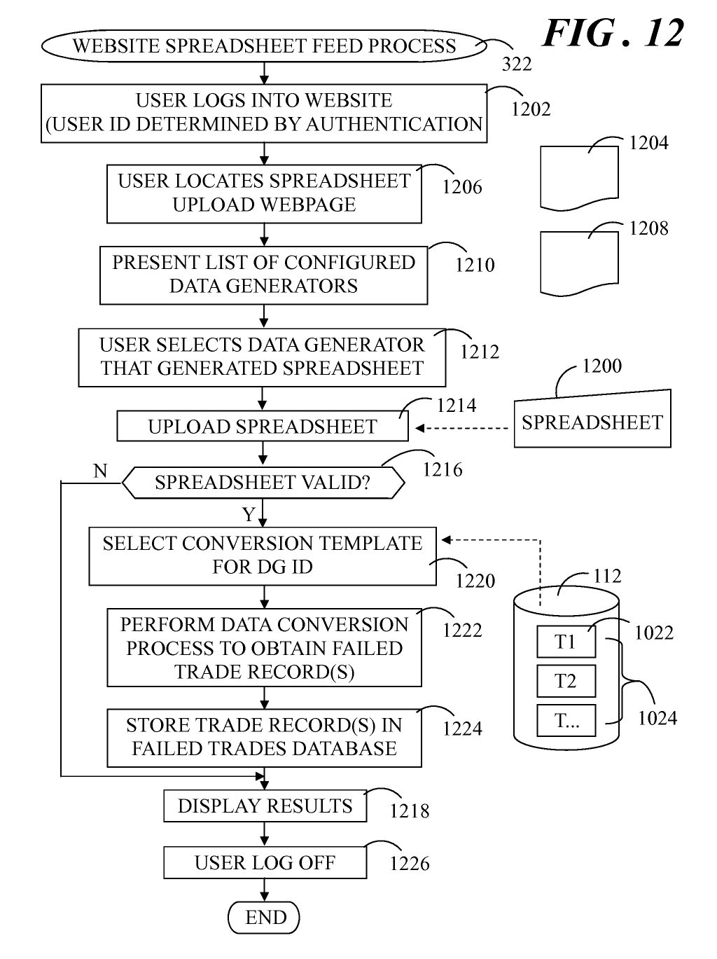

Currently, data generators 118 have various means of delivering spreadsheets containing trade data to their data consumer 120 clients. The data generators 118 that send these spreadsheets typically follow a consistent format. Failed trade reporting system 100 is configured to enable an investment manager to upload trade data 116 they already have into system 100, even if the broker-dealer or custodian does not have a data feed established with system 100. In such a scenario, data generator 118E is the investment manager. As such, data generator 118E is also data consumer 120. Data generator 118E provides trade data 116E as a spreadsheet via manual upload, which can subsequently be received in accordance with website component 312 of failed trade reporting system 100. In response to the receipt of spreadsheet of trade data 116E, website spreadsheet feed process 320 is executed to convert spreadsheet of trade data 116E into a standardized format. Website spreadsheet feed process 322 will be discussed in connection with FIG. 12.

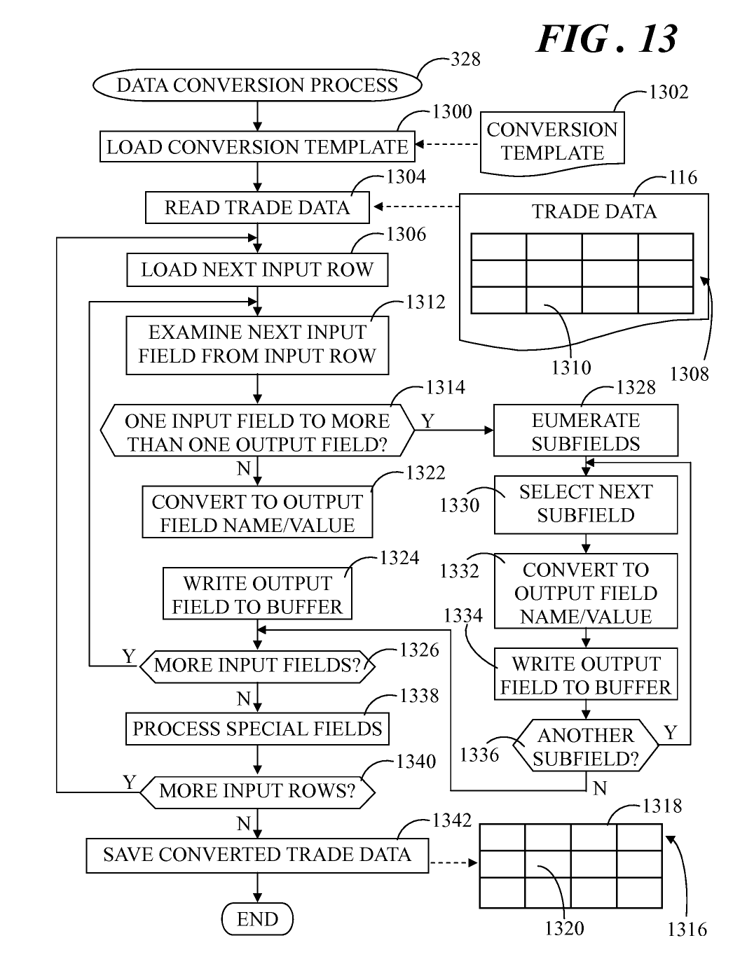

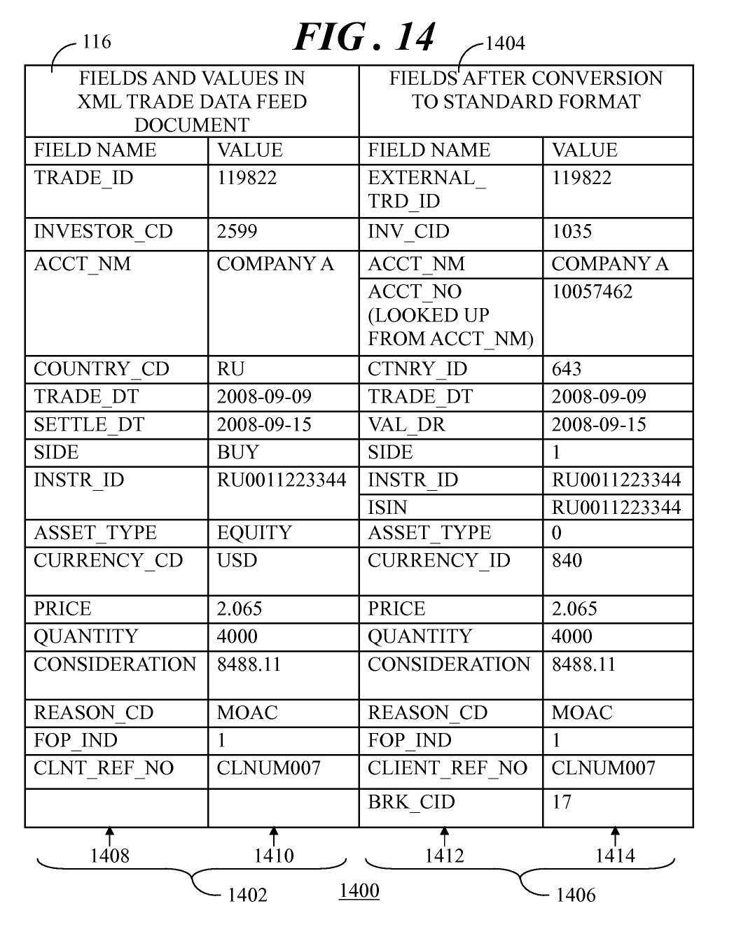

Each of web service feed process 314, SWIFT message feed process 316, e-mail spreadsheet feed process 318, FTP spreadsheet feed process 320, and website spreadsheet feed process 322 execute a data conversion process 328 to convert their corresponding trade data 116A, 116B, 116C, 116D, and 116E into a standardized format. Data conversion process 328 makes use of conversion templates stored in conversion template database 112. Data conversion process 328 will be discussed in connection with FIGS. 13 and 14.

The outcome of execution of any of web service feed process 314, SWIFT message feed process 316, e-mail spreadsheet feed process 318, FTP spreadsheet feed process 320, and website spreadsheet feed process 322 is the generation of failed trade records 202. Failed trade records 202 are subsequently stored in failed trades database 114.

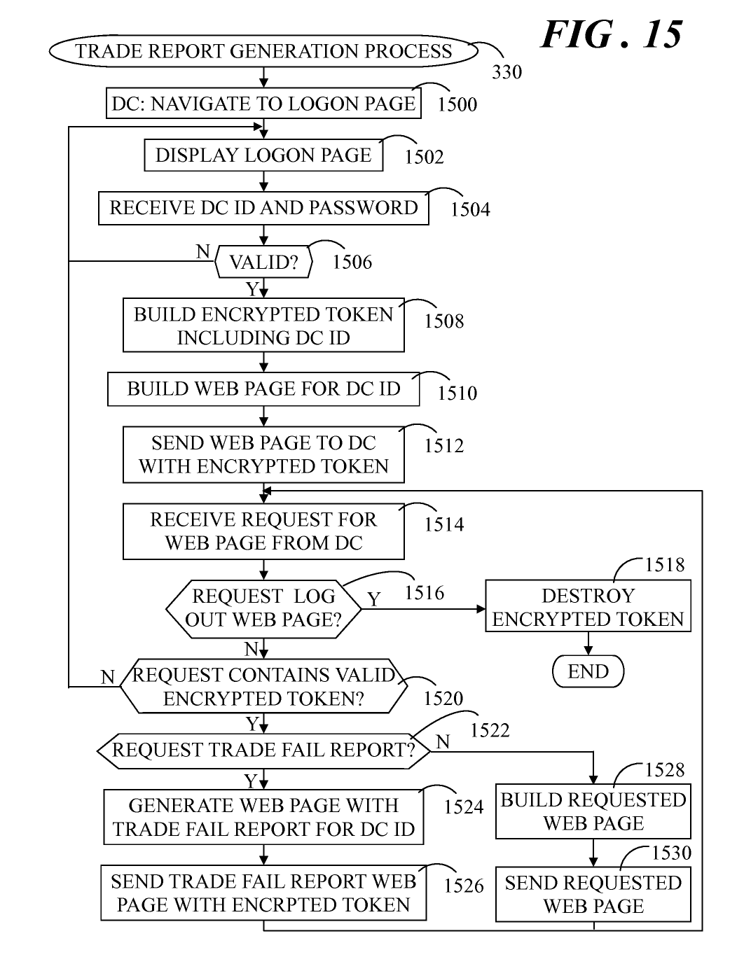

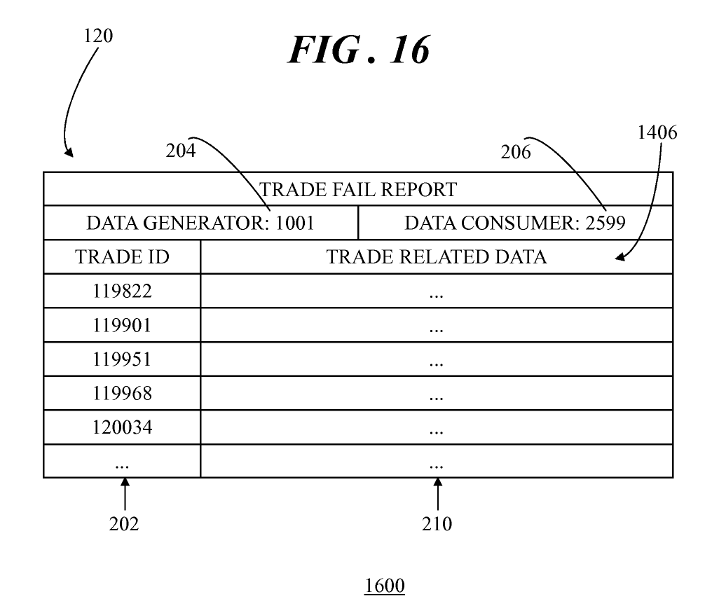

Trade reporting system 104 includes executable code in the form of a trade report generation process 330. Data consumer 120 may send a request 332 for a trade fail report to failed trade reporting system 100. For example, data consumer 120 may send request 332 via an Internet web service. In response to the received request 332, trade report generation process 330 is executed to provide trade fail report 120. Trade report generation process 330 accesses failed trades database to obtain a particular subset of trade records 202 and generate trade fail report 120. Trade report generation process 330 will be discussed in connection with FIGS. 15 and 16.

### FIG. 4

FIG. 4 shows a flowchart exemplifying web service feed process 314 executed in accordance with failed trade reporting system 100. In general, web service feed process 314 includes a receive subprocess 400 and a processing subprocess 402. At receive subprocess 400, trade data 116A (FIG. 3) is received from data generator 118A (FIG. 3) over the Internet. Through the execution of receive subprocess 400, trade data 116A is stored in a data queue 404 at failed trade reporting system 100.

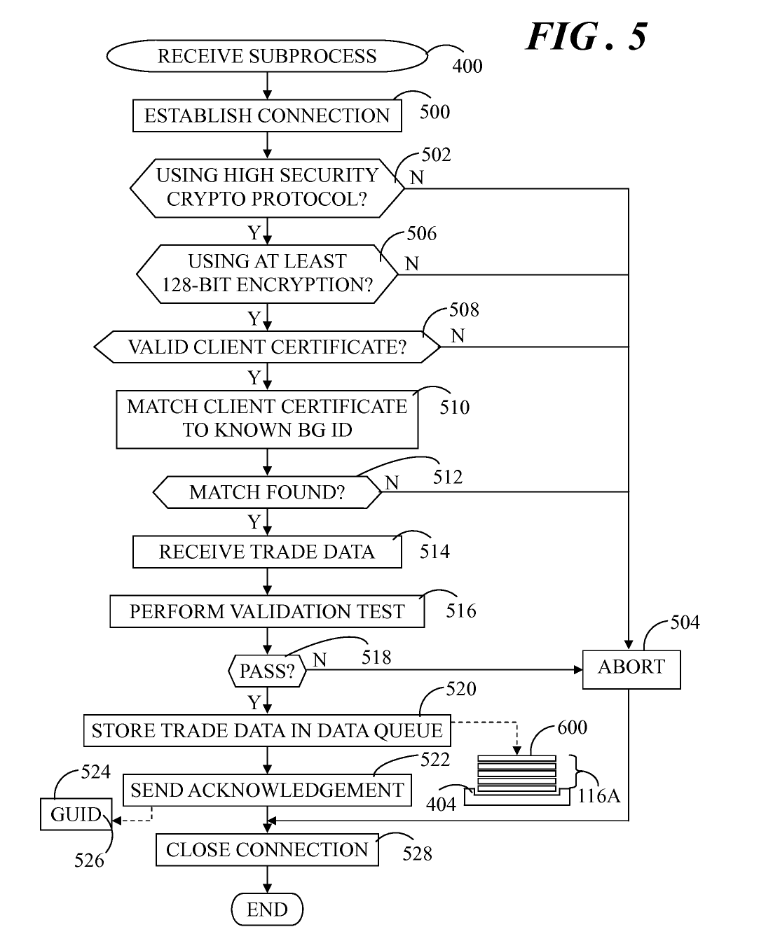

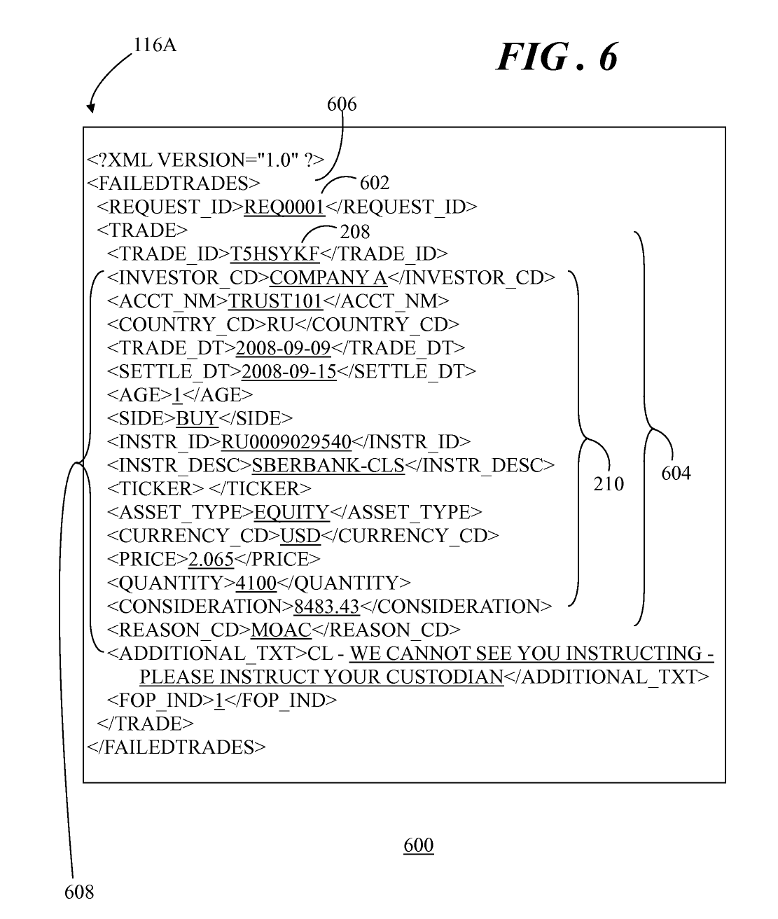

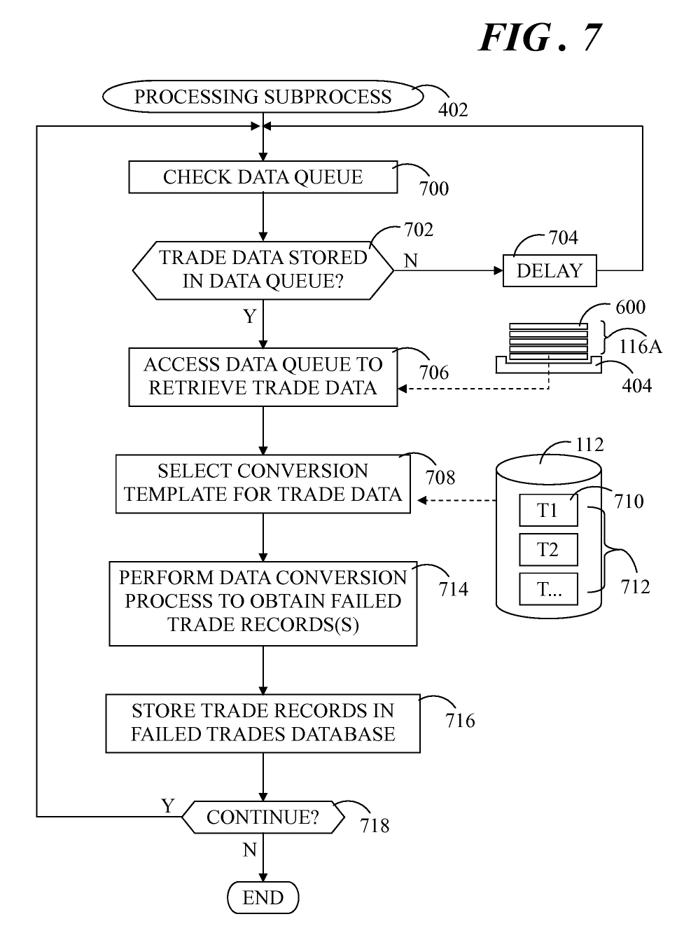

Processing subprocess 402 is performed asynchronous to receive subprocess 400. That is, the activities of processing subprocess 402 are not performed in cooperation with the execution of receive subprocess 400. Rather, processing subprocess 402 is a background service that continuously monitors data queue 404 for the presence of trade data 116A and then processes trade data 116A in a first-in first-out basis. Receive subprocess 400 is discussed in connection with FIGS. 5 and 6, and processing subprocess 402 is discussed in connection with FIG. 7.

In an embodiment, web service feed process 314 operates over Hypertext Transfer Protocol, Secure (HTTPS). HTTPS is an universal resource locator (URL) scheme used for secure transmissions. HTTPS refers to the combination of a normal HTTP interaction over an encrypted Secure Sockets Layer (SSL) or Transport Layer security (TLS) connection. This ensures reasonable protection from eavesdroppers. For security reasons, web service feed process 314 does not operate over regular unencrypted Hypertext Transfer Protocol (HTTP). In addition, at least 128-bit strength encryption over SSL 3.0 or TLS 1.0 is allowed. Again, for security reasons, weaker protocols are not allowed.

A sending party, i.e., data generator 118A (FIG. 3) is identified by a digital client certificate. The digital client certificate must have been issued by a trusted Certificate Authority. Web service feed process 314 will not accept connection requests from data generators 118A that do not present a valid and trusted digital client certificate. All data generators 118A that are allowed to send trade data 116A into failed trades reporting system 100 will have been issued a client certificate. The client certificate may be associated with data generator identifier 204 in system 100. System 100 will further reject requests from valid client certificates that are not associated with data generator identifier 204 in failed trades reporting system 100.

Because web server component 304 employs HTTPS and because data generator 118A must present a trusted client certificate, system 100 is said to employ mutual authentication where during the transaction both data generator 118A and web server component 304 know who each other are to a high degree of certainty. HTTPS also encrypts the communication making it impossible for third parties to view trade data 116A should they be able to intercept the communications.

### FIG. 5

FIG. 5 shows a flowchart of receive subprocess 400 of web service feed process 314. Receive subprocess 400 is executed when data generator 118A (FIG. 3) wishes to feed trade data 116A (FIG. 3) to failed trades reporting system 100.

Receive subprocess 400 begins with a task 500. At task 500, a client attempts to connect to a known URL for web service feed process 314. In this example, “client” refers to a computing system that belongs to a subscribing data generator 118A. Data generator 118A may be either a broker-dealer or a custodian.

In response to task 500, subprocess 400 continues with a query task 502. At query task 502, data generator 118A checks that the SSL Certificate that web server component 304 presents is valid for the given URL, within its validity start and end dates, and signed by a well known and trusted Certificate Authority. In addition, web server component 304 checks to verify that data generator 118A is using either SSL 3.0 or TLS 1.0. Thus, a determination is made at query task 502 that a high security cryptographic protocol is being used.

If a determination is made at query task 502 that these conditions of the high security cryptographic protocol are not satisfied, process control proceeds to a task 504. At task 504, either data generator 118A or web server component 304 aborts the connection and receive subprocess 400 ends. However, when a determination is made at query task 504 that the conditions of the high security cryptographic protocol are satisfied, receive subprocess 400 continues with a query task 506.

At query task 506, web server component 304 checks to verify that data generator 118A is using at least 128-bit strong encryption. If 128-bit strong encryption is not being used, process control proceeds to task 504 where the connection is aborted and subprocess 400 ends. However, when 128-bit strong encryption is being used, receive subprocess 400 continues with a query task 508.

At query task 508, web server component 304 checks to verify that data generator 118A is presenting a digital client certificate and that the digital client certificate is within its validity start and end dates. In addition, web server component 304 checks to verify that the digital client certificate is signed by a well known and trusted Certificate Authority. When the conditions of query task 508 are not met, process control proceeds to task 504 to abort the connection and end receive subprocess 400. However, when the conditions of query task 508 are being met, receive subprocess 400 continues with a task 510.

At task 510, web server component 304 then checks its associated database (not shown) to see if the digital client certificate that was presented by the client has been mapped to a subscribing data generator 118A.

A query task 512 is performed in connection with task 510. Query task 512 determines whether a match is found. When a match is not found, indicating that the entity attempting the connection is not a subscribing data generator 118A, process control proceeds to task 504 to abort the connection and end receive subprocess 400. However, when a match is found at query task 512, data generator identifier 204 is determined and the connection is authenticated. Receive subprocess 400 continues with a task 514 following authentication.

At task 514, data generator 118A is free to send web server component 304 trade data 116A (FIG. 3). In this scenario, trade data 116A is an XML trade feed document that describes the failed trades.

### FIGS. 5 and 6

Referring to FIG. 6 in connection with task 514, FIG. 6 shows an exemplary XML document 600 of trade data 116A that may be sent to web server component 304 of failed trades reporting system 100. Document 600 includes a request identifier 602 and associated information 604 for at least one failed trade 606. Request identifier 602 is unique identification that identifies a batch of failed trades 606 that are being sent by data generator 118A (FIG. 3). Request identifier 602 may be generated by failed trades reporting system 100. Alternatively, request identifier 602 may be generated by data generator 118A feeding trade data 116A into failed trades reporting system 100. System 100 uses the concept of a “snapshot feed” and request identifier 602 is used to define the scope of a snapshot. This allows a large snapshot of trade data 116A to be delivered in bits and pieces by keeping request identifier 602 the same across the individual bits and pieces.

Information 604 can include trade identifier 208 and trade related data 210. Trade related data 210 can be presented in a number of formats, with fields 608 identifying the various values for trade related data 210 being non-standard. Document 600 is provided for illustrative purposes. It should be understood that the document 600 can have various fields 608 using various nomenclature and can have different information 604 then that which is shown.

### FIG. 5 (Continued)

In response to the receipt of trade data 116A (FIG. 3) at task 514, a task 516 is performed. At task 516, web server component 304 of failed trades reporting system 100 performs a basic validation to ensure that document 600 contains request identifier 602 and the required fields 608 of information 604 for at least one failed trade 606.

A query task 518 is performed in connection with task 516. At query task 518, a determination is made as to whether the basic validation passes. If query task 518 determines that document 600 does not pass the basic validation testing of task 516, program control proceeds to task 504 where the connection is aborted and receive subprocess 400 ends. However, when query task 518 determines that document 600 passes the basic validation testing of task 516, receive subprocess 40 continues with a task 520.

At task 520, web server component 304 places trade data 116A in data queue 404 for later processing in accordance with processing subprocess 402. This asynchronous design in which trade data 116A is placed in data queue 404 for later processing allows web server component 304 to accept trade data 116A from multiple data generators 118A at high burst rates.

Following task 520, a task 522 is performed. At task 522, web server component 304 sends an acknowledgement message 524 to data generator 118A (FIG. 3). Acknowledgement message 524 indicates that trade data 116A from data generator 118A has been successfully received at failed trades reporting system 100. In an embodiment, web server component 304 sends data generator 118A a globally unique identifier (GUID) string 526 in acknowledgement message 524 to uniquely identify this transaction, i.e., receipt of trade data 116A. GUID string 526 may be used later to look up the asynchronous results of the transaction. Note that if XML document 600 fails the basic validation at query task 518, web server component 304 may send this information immediately to data generator 118A in connection with abort task 504. Data generator 118A will not receive GUID string 526 because the transaction, i.e., receipt of trade data 116A, has been aborted and no further processing will be done.

Following task 522, receive subprocess 400 continues with a task 528. At task 528, web server component 304 and data generator 118A close the connection and receive subprocess 400 ends.

### FIG. 7

FIG. 7 shows a flowchart of processing subprocess 402 of web service feed process 314. Processing subprocess 400 is a background service that continuously monitors data queue 404 for trade data 116A in the form of XML documents 600 and processes documents 600 in a first-in, first-out basis.

Processing subprocess 402 begins with a task 700. At task 700, processor 106 checks data queue 404 for trade data 116A.

A query task 702 is performed in connection with task 700. At query task 702, a determination is made as to whether there is currently any trade data 116A stored in data queue 404. When there is no trade data 116A in data queue 404, subprocess 402 proceeds to a task 704. At task 704, processor 106 imposes a time delay to processing subprocess 402. Following the imposed time delay at task 704, process control loops back to task 700 to again check data queue 404 for trade data 116A. However, when a determination is made at query task 702 that there is trade data 116A stored in data queue 404, processing subprocess 402 continues with a task 706.

At task 706, data queue 404 is accessed to retrieve XML document 600 of trade data 116A.

Next, a task 708 is performed. At task 708, a conversion template for XML document 600 of trade data 116A is selected from conversion template database 112. In an example illustration, an XML conversion template 710, labeled T1, is selected. At task 708, processor 106 may check to see if the particular data generator 118A sending trade data 116A is configured for standard or custom data feeds. In an embodiment, a standard data feed of trade data 116A may be largely the same across a number of data generators 118A. However, a custom data feed is customized for a particular one of data generators 118A. For example, data generators 118A may send trade data 116A via a standard secure web service. Alternatively, data generators 118A may send trade data 116A via a custom secure web service. Accordingly, determination of a standard or custom data feed may be called for in order to select an appropriate one of XML conversion templates 712 from conversion template database 112 for use in processing trade data 116A. Moreover, a separate XML conversion template 712 may be required for each different data generator 118A who uses the custom web service to feed data.

Following the selection of XML conversion template 710, processing subprocess 402 continues with a task 714. At task 714, data conversion process 328 is executed in order to obtain failed trade records 202 in a standardized format. Data conversion process 328 is discussed in connection with FIGS. 13 and 14. Data conversion process 328 utilizes the selected XML conversion template 710 in order to effectuate the conversion of XML document 600 of trade data 116A to form failed trade records 202 in a standardized format.

A task 716 is performed in response to task 714. At task 716, failed trade records 202 are stored in failed trades database 114. In an embodiment, for each of failed trade records 202 to be stored in database 114 and based on the specified trade identifier 208, processor 106 tried to locate an existing trade identifier 208 previously stored in database 114. If one is found, trade record 202 is marked as valid and is updated with trade related data 210 in database 114. If no previous failed trade record 202 is found in database 114 having the specified trade identifier 208, a new one of failed trade records 202 is created in failed trades database 114 with the supplied trade related data 210.

Following task 716, a query task 718 is performed. At query task 718, a determination is made as to whether the execution of processing subprocess 402 is to continue. When subprocess 402 is to continue, process control loops back to task 700 to again check data queue 404 for trade data 116A. However, when subprocess 402 is to be discontinued, subprocess 402 ends.

### FIG. 8

FIG. 8 shows a flowchart of a provider site SWIFT message management process 800 executed in accordance with failed trade reporting system 100. As briefly mentioned above, data generator 118B (FIG. 3) can provide trade data 116B (FIG. 3) via SWIFT messaging. Failed trades reporting system 100 is able to receive trade data 116B of trade fail information from SWIFT messages primarily using the MT548 message format. However, in alternative embodiments, system 200 can also accept the MT537 and MT540-MT547 message formats for receiving additional trade related information. In general, data generator 118B, who may be a custodian, sends trade data 116B via the SWIFT network to failed trades reporting system 100 by addressing the message to the BIC code for system 100. In an embodiment, system 100 can maintain a non-connected BIC and can receive messages via provider 326 that is on the SWIFT network. Provider site SWIFT message management process 800 describes operations that may be occurring at provider 326 to enable receipt of SWIFT messages of trade data 116B at SWIFT polling component 306.

Process 800 begins with a task 802. At task 802, provider 326 monitors for a SWIFT message of trade data 116B.

In response to monitoring task 802, process 800 continues with a task 804. At task 804, provider 326 obtains a SWIFT message of trade data 116B.

Next at a task 806, provider 326 converts the SWIFT message of trade data 116B to XML format according to specifications set forth by failed trades reporting system 100.

A task 808 is performed in response to task 806. At task 808, provider 326 stores trade data 116B in XML format on a secure file transfer protocol (FTP) website 810 operated by provider 326.

A query task 812 is performed following task 808. At query task 812, a determination is made as to whether the execution of provider site SWIFT message management process 800 is to continue. When process 800 is to continue, process control loops back to task 802 to again monitor for a SWIFT message of trade data 116B. However, when a determination is made that process 800 is to be discontinued, process 800 ends.

### FIG. 9

FIG. 9 shows a flowchart of SWIFT message feed process 316 executed by processor 106 in accordance with failed trade reporting system 100.

SWIFT message feed process 316 begins with a task 902. At task 902, a secure tunnel is established between provider 326 and failed trades reporting system 100. This may be accomplished using an SSH tunnel and a client certificate provided by provider 326 operating the Secure FTP Site. A secure shell or SSH is a network protocol that allows data to be exchanged using a secure channel between two networked devices, in this case, between provider 326 and SWIFT polling component 306 of system 100. Used primarily on Linux and Unix based systems to access shell accounts, SSH was designed as a replacement for TELNET and other insecure remote shells, which sent information, notably passwords, in plaintext, leaving them open for interception. The encryption used by SSH provides confidentiality and integrity of data over an insecure network, such as the Internet.

Following task 902, a task 904 is performed. At task 904, SWIFT message polling component 306 checks for trade data 116 stored at secure FTP website 810.

A query task 906 is performed in connection with task 904. At query task 906, SWIFT polling component 306 determines whether there is one or more SWIFT messages containing trade data 116B stored at secure FTP website 810. When there is no SWIFT message trade data 116B stored at secure FTP website 810, process 316 proceeds to a task 908.

At 908, SWIFT message polling component 306 closes the connection, i.e., closes the secure SSH tunnel to provider 326, and SWIFT message feed process 316 ends. However, when there is SWIFT message trade data 116B stored at secure FTP website 810, process 316 continues with a task 910.

At task 910, a SWIFT message 912 of trade data 116B is downloaded from secure FTP website 810.

In response to SWIFT message 912 of trade data 116B downloaded at task 910, a task 914 is performed. At task 914, data generator identifier 204 for the downloaded SWIFT message 912 is determined from trade data 116B.

Next, a task 916 is performed. At task 916, a SWIFT message conversion template 918 is selected from various SWIFT message conversion templates 920 stored in conversion template database 112.

Next, a task 922 is performed. At task 922, data conversion process 328 is executed in order to obtain a failed trade record 202 in a standardized format from SWIFT message 912. Data conversion process 328 is discussed in connection with FIGS. 13 and 14. Data conversion process 328 utilizes the selected SWIFT message conversion template 918 in order to effectuate the conversion of SWIFT message 912 (converted to XML format by provider 326) to form one of failed trade records 202 in a standardized format. In an embodiment, SWIFT message conversion templates 920 have been specifically configured for SWIFT messages (converted to XML format by provider 326). A different one of templates 920 may be required for different data generators 118B (FIG. 3) and types of SWIFT messages 912.

Following task 922, a task 924 is performed. At task 924, one of failed trade records 202 related to SWIFT message 912 is stored in failed trades database 114. In this scenario, request identifier 602 is not utilized for SWIFT messages 912 because SWIFT message 912 is not a snapshot feed. Rather, each SWIFT message 912 is processed independently from the others.

Following task 924, a task 926 is performed. At task 926, SWIFT polling component 306 sends provider 326 a message to delete SWIFT message 912 of trade data 116B from secure FTP website 810. Following task 926, process control loops back to task 902 to establish a secure SSH tunnel to provider site and check for additional SWIFT messages 912 of trade data 116B stored at secure FTP website 810.

### FIG. 10

FIG. 10 shows a flowchart of e-mail spreadsheet feed process 318 executed in accordance with failed trade reporting system 100. If data generator 118C (FIG. 3) wishes to send trade data 116C (FIG. 3) to data consumer 122 through e-mail messaging, a mailbox 1000 may be setup at failed trade reporting system 100. Mailbox 1000 will receive trade data 116C in the form of an e-mail message 1002 having at least one attached e-mailed spreadsheet 1004 from a distinct data generator 118C intended for a distinct data consumer 122. Mailbox 1000 uniquely identifies data generator identifier 204 for the sending data generator 118C and data consumer identifier 206 for the intended recipient data consumer 122. Mailbox 1000 may be provided in a listing 1006 of configured incoming mailboxes maintained by mail server component 308.

In an embodiment, mail server component 308 of failed trades reporting system 100 supports secure simple mail transfer protocol (SMTP) to prevent the e-mail from being intercepted on the Internet. However, if the e-mail server of the sending data generator 116C does not support Secure SMTP, mail server component 308 will downgrade to regular SMTP. To protect from forged e-mail headers, mail server component 308 may additionally perform a reverse-DNS (domain name system) lookup to verify that the internet protocol (IP) address of the sending data generator 116C matches that in the e-mail header.

E-mail spreadsheet feed process 318 begins with a task 1008. At task 1008, mail server component 308 identifies listing 1006 of configured incoming mailboxes.

Next, a task 1010 is performed. At task 1010, mail server component 308 selects a “next” mailbox 1000 from listing 1006. Of course, during a first iteration of process 318, the “next” mailbox 1000 will be a first mailbox 1000 from listing 1006.

A query task 1012 is performed in connection with task 1010. At query task 1012, mail server component 308 determines whether an e-mail message 1002 of trade data 116C (FIG. 3) is present in the selected mailbox 1000. When e-mail message 1002 of trade data 116C is not present in mailbox 1000, process control proceeds to a query task 1014.

At query task 1014, a determination is made as to whether there are additional mailboxes 1000 in listing 1006 that should be polled. When there are no additional mailboxes 1000, e-mail spreadsheet feed process 318 exits. However, when there are additional mailboxes 1000, process 318 loops back to task 1010 to select the next mailbox 1000 from listing 1006. Thus, mail server component 308 may periodically poll all configured incoming mailboxes 1000 for e-mail message 1002, for example, every minute.

When a determination is made at query task 1012 that e-mail message 1002 of trade data 116C is present in mailbox 1000, process control proceeds to a task 1016. At task 1016, one e-mail message 1002 is downloaded to failed trades reporting system 100 via mail server component 308.

Next, a task 1018 is performed. At task 1018, mail server component 308 extracts, validates, and specifies spreadsheet attachments to e-mail message 1002. In an embodiment, mail server component 308 first checks the e-mail headers to verify that e-mail message 1002 came from data generator 118C that is allowed to send to that mailbox 1000. E-mail message 1002 is then checked for attachments. These attachments may be spreadsheets 1004, and more particularly, Microsoft Excel spreadsheets. In accordance with task 1018, an XML spreadsheet validation template (not shown) may be loaded for the sending data generator 118C. The attached spreadsheets 1004 are validated against the spreadsheet validation template. Further validation may be performed to check whether trade data 116C in spreadsheets 1004 is indeed meant for the receiving data consumer 122. This extra validation may be done whenever spreadsheets 1004 contain data consumer identifier 206 that uniquely identifies data consumer 122 associated with trade data 116C.

Following task 1018, a task 1020 is performed. At task 1020, a spreadsheet conversion template 1022 associated with data generator 116C is selected from various spreadsheet conversion templates 1024 stored in conversion template database 112.

Next, a task 1026 is performed. At task 1026, data conversion process 328 is executed in order to obtain a failed trade records 202 in a standardized format from spreadsheet 1004. Data conversion process 328 is discussed in connection with FIGS. 13 and 14. Data conversion process 328 utilizes the selected spreadsheet conversion template 1022 in order to effectuate the conversion of trade data 116C in spreadsheet 1004 to form one or more failed trade records 202 in a standardized format.

In response to task 1026, a task 1028 is performed. At task 1028, failed trade records 202 are stored in failed trades database 114. In an embodiment, prior to processing spreadsheet 1004, failed trades reporting system 100 checks to see if a new request identifier 602 must be generated. A new request identifier 602 may be generated once per business day. Using a new or existing request identifier 602, all previous trade records 202 sent by data generator 116C, processed by the current spreadsheet conversion template 1022, and not matching the provided request identifier 602 are marked as invalidated in the failed trades database 114. The implication here is that a “snapshot” typically lasts twenty-four hours. Failed trades reporting system 100 may support a global customer-base. Consequently, the exact moment when the business day rolls over is configurable per data consumer identifier 122.

Based on trade identifiers 208 specified in spreadsheet 1004, system 100 tries to locate one of trade records 202 already stored in failed trades database 114 that matches trade identifiers 208. If one is found, trade record 202 is marked as valid and is updated with the supplied data. If no trade record 202 is found, a new trade record 202 is created in failed trades database 114 with the supplied data.

Following task 1028, a query task 1030 is performed. At query task 1030, a determination is made as to whether trade fail report 120 should be e-mailed to data consumer 122. When a determination is made not to e-mail trade fail report 120 to data consumer 122, e-mail spreadsheet feed process 318 proceeds to query task 1014. However, when trade fail report 120 is to be e-mailed to data consumer 122 process 318 continues with a task 1032.

At task 1032, trade fail report 120 is generated by executing trade report generation process 330. Trade report generation process 330 is discussed in connection with FIGS. 15 and 16.

A task 1034 is performed in response to task 1032. At task 1034, one or more trade fail reports 120 is e-mailed to data consumer 122. Following task 1034, process 318 continues with query task 1014, as discussed above.

### FIG. 11

FIG. 11 shows a flowchart of FTP spreadsheet feed process 320 executed in accordance with failed trade reporting system 100. Instead of having data generators 118 send spreadsheets via e-mail, data generator 118D (FIG. 3) may alternatively wish to provide failed trade reporting system 100 these spreadsheets via a secure FTP site 1100. Secure FTP site 1100 may be operated by data generator 118D, and each secure FTP site 1100 represents one unique data generator identifier 204 from the perspective of system 100. Spreadsheets 1102 of trade data 116D intended for different data consumers 122 can be distinguished by the name of spreadsheet 1102 and/or their location on secure FTP site 1100.

FTP spreadsheet feed process 320 begins with a task 1104. At task 1104, a secure tunnel is established between data generator 118D and FTP polling component 310 of failed trades reporting system 100. This may be accomplished using an SSH tunnel and a client certificate provided by data generator 118D operating secure FTP site 1100.

FTP spreadsheet feed process 320 continues with a task 1106. At task 1106, FTP polling component 310 checks for spreadsheet(s) 1102 of trade data 116D stored at secure FTP site 1100.

A query task 1108 is performed in connection with task 1106. At query task 1108, FTP polling component 310 determines whether there are one or more spreadsheets 1102 of trade data 116D stored at secure FTP site 1100. When there are no spreadsheets 1102 of trade data 116D stored at secure FTP site 1100, process 320 proceeds to a task 1110.

At 1110, FTP polling component 310 closes the connection, i.e., closes the secure SSH tunnel to data generator 118D (FIG. 3), and FTP spreadsheet feed process 320 ends. However, when there is one or more spreadsheet 1102 of trade data 116D stored at secure FTP site 1100, process 320 continues with a task 1112.

At task 1112, one spreadsheet 1102 of trade data 116D is downloaded from secure FTP site 1100.

A task 1114 is performed in response to task 1112. At task 1114, a spreadsheet conversion template 1022 is selected from the various spreadsheet conversion templates 1024 stored in conversion template database.

Next, a task 1116 is performed. At task 1116, data conversion process 328 is executed in order to obtain failed trade records 202 in a standardized format from spreadsheet 1102. Data conversion process 328 is discussed in connection with FIGS. 13 and 14. Data conversion process 328 utilizes the selected spreadsheet conversion template 1022 in order to effectuate the conversion of trade data 116D in spreadsheet 1102 to form one or more failed trade records 202 in a standardized format.

In response to task 1116, a task 1118 is performed. At task 1118, failed trade records 202 are stored in failed trades database 114. Spreadsheet 1102 is processed in a manner identical to that discussed in connection e-mail spreadsheet feed process 318 in FIG. 10. As such, this processing is not repeated herein for brevity.

Following task 1118, a task 1120 is performed. At task 1120, spreadsheet 1102 of trade data 116D (FIG. 3) is deleted from secure FTP site 1100.

Next, a query task 1122 is performed. At query task 1122, a determination is made as to whether trade fail report 120 should be e-mailed to data consumer 122. When a determination is made not to e-mail trade fail report 120 to data consumer 122, FTP spreadsheet feed process 320 loops back to task 1106 to check for another of spreadsheets 1102 at secure FTP site 1100. However, when trade fail report 120 is to be e-mailed to data consumer 122, process 320 continues with a task 1124.

At task 1124, trade fail report 120 is generated by executing trade report generation process 330. Trade report generation process 330 is discussed in connection with FIGS. 15 and 16.

A task 1126 is performed in response to task 1124. At task 1126, one or more trade fail reports 120 is e-mailed to data consumer 122. Following task 1166, process 320 loops back to task 1106 to check for another of spreadsheets 1102 at secure FTP site 1100.

### FIG. 12

FIG. 12 shows a flowchart of a website spreadsheet feed process 322 executed in accordance with failed trade reporting system 100. As mentioned previously, currently data generators 118 already have various means of delivering spreadsheets containing trade data 116 to their clients, i.e., data consumers 122. Data generators 118 that send these spreadsheets typically follow a consistent format. Conversion template database 112 includes spreadsheet conversion templates 1024 for many of the common formats that are used. Accordingly, a data generator 118E, who in this special instance may be an investment manager, can upload a spreadsheet 1200 of trade data 116E that they already have into failed trades reporting system 100, even if the sending broker-dealer or custodian does not have a data feed capability established with failed trades reporting system 100. This trade data can then be normalized to the standard format, allowing the investment manager, who is now a data consumer 122 to view trade records 202 from spreadsheet 1200 side-by-side with other trade records 202 that may have arrived through other types of feeds.

Website spreadsheet feed process 322 begins with a task 1202. At task 1202, an investment manager user, i.e., as data generator 118E, logs into a website 1204 maintained in connection with website component 312. The investment manager user will be associated with data consumer identifier 206 for that investment manager.

In response to log in at task 1202, a task 1206 is performed. At task 1206, the user locates a spreadsheet upload web page 1208.

In response to task 1206, a task 1210 is performed. At task 1210, a list of configured data generators 118 is presented to the user.

Next, a task 1212 is performed. At task 1212, the user interactively selects data generator 118E (i.e., broker-dealer or custodian) who sent spreadsheet 1200. This also determines data generator identifier 204 of the sender of spreadsheet 1200.

Following task 1212, a task 1214 is performed to upload spreadsheet 1200 to website component 312 via, for example, spreadsheet upload web page 1208.

Next, a query task 1216 is performed. At query task 1216, a determination is made as to whether the uploaded spreadsheet 1200 is valid. When spreadsheet 1200 is not valid, website spreadsheet feed process 322 proceeds to a task 1218.

At task 1218 the results are displayed. Accordingly, when spreadsheet is not valid, any errors that are encountered can be displayed to the user immediately due to the interactive operations of website spreadsheet feed process 322. However, when a determination is made at query task 1216 that the uploaded spreadsheet 1200 is valid, process control proceeds to a task 1220.

At task 1220, a spreadsheet conversion template 1022 is selected from the various spreadsheet conversion templates 1024 stored in conversion template database 112.

Next, a task 1222 is performed. At task 1222, data conversion process 328 is executed in order to obtain failed trade records 202 in a standardized format from spreadsheet 1200. Data conversion process 328 is discussed in connection with FIGS. 13 and 14. Data conversion process 328 utilizes the selected spreadsheet conversion template 1022 in order to effectuate the conversion of trade data 116E (FIG. 3) in spreadsheet 1200 to form one or more failed trade records 202 in a standardized format.

In response to task 1222, a task 1224 is performed. At task 1224, failed trade records 202 are stored in failed trades database 114. Spreadsheet 1200 is processed in a manner identical to that discussed in connection e-mail spreadsheet feed process 318 in FIG. 10, and is not repeated herein for brevity.

Following task 1224, process 322 continues with task 1218 at which results may be displayed. Such results include for example, the provision of trade fail report 120.

Following task 1218, a task 1226 is performed. At task 1226, the user breaks the connection by logging off of website 1204 and process 322 ends.

### FIG. 13

FIG. 13 shows a flowchart of data conversion process 328 executed in accordance with failed trade reporting system 100. It should be recalled that each of web service feed process 314, SWIFT message feed process 316, e-mail spreadsheet feed process 318, FTP spreadsheet feed process 320, and website spreadsheet feed process 322 receive trade data 116 and convert that trade data 116 to a standardized format. Data conversion process 328 provides the necessary conversion.

Data conversion process 328 begins with a task 1300. At task 1300, the selected conversion template 1302 is loaded. It should be recalled that the selected conversion template 1302 can be any of a number of conversion templates stored in conversion template database 112 and selected in response to operations associated with each of the above listed feed processes 314, 316, 318, 320, and 322.

Data conversion process 328 continues with a task 1304. At task 1304, trade data 116 is read. Again, it should be recalled that trade data 116 may be in an XML format or a spreadsheet format and was received in response to operations associated with each of the above listed feed processes 314, 316, 318, 320, and 322.

Following task 1304, a task 1306 is performed. At task 1306, a next input row of trade data 116 is loaded. Of course in a first iteration of data conversion process 328, the “next” row will entail the loading of a first row of trade data 1146. In an embodiment, individual failed trades may be delineated in separate input rows 1308 in an input spreadsheet format of trade data 116 and trade related data may be delineated in separate input fields 1310. Accordingly, data conversion process 328 individually processes each of the individual failed trades within trade data 116.

In response to task 1306, a task 1312 is performed. At task 1312, the next input field 1310 from the loaded input row 1308 is exampled. Again, during a first iteration of data conversion process 328, the “next” input field 1310 will entail the examination of a first input field 1310 for the loaded input row 1308.

A query task 1314 is performed in cooperation with task 1312. At query task 1314, a determination is made as to whether the one input field 1310 should be converted to more than one output field. In the illustrated embodiment, individual trade records may be delineated in separate output rows 1316 in a output spreadsheet format of converted trade data 1318 and the converted trade related data may be delineated in separate output fields 1320. There may not be a one-to-one correlation between fields 1310 and 1320. Rather, through the application of conversion template 1302, fields 1310 can be properly mapped to fields 1320. Accordingly, data conversion process 328 individually processes each of the individual fields 1310 within the input spreadsheet of trade data 116.

When a determination is made at query task 1314 that the one input field 1310 is to be converted to a single output field 1320, process 328 continues with a task 1322. At 1322, the information contained in input field 1320 is converted to the output field name and value in accordance with conversion template 1302.

Next, a task 1324 is performed to write this output field 1320 and its value to a buffer (not shown).

Following task 1324, data conversion process 328 proceeds to a task query task 1326, discussed below.

Returning to query task 1314, when a determination is made that input field 1310 is to be converted to more than one output field 1320, data conversion process 328 continues with a task 1328.

At task 1328, each of the subfields are enumerated, or individually specified. Next, a task 1330 is performed. At task 1330, a next subfield within the input field 1310 is selected. During a first iteration of task 1330, the “next” subfield within input field 1310 will be a first subfield.

Following task 1330, a task 1332 is performed. At task 1332, the information contained in the next subfield of input field 1320 is converted to the output field 1320 name and value in accordance with conversion template 1302.

A task 1334 is performed in connection with task 1332 to write this output field 1320 and it value to a buffer (not shown).

Following task 1334, a determination is made at a query task 1336 as to whether the input field 1310 includes another subfield. When it does, process control loops back to task 1330 to perform a conversion of the next subfield. However, when there are no further subfields within the input field 1310, data conversion process 328 proceeds to query task 1326.

At query task 1326, performed following either of task 1324 or a negative outcome of query task 1336, a determination is made as to whether the loaded input row 1308 includes additional input fields 1310. When a determination is made at query task 1326 that there is another input field 1310, program control loops back to task 1312 to examine the next input field 1310 and process it according to the previously described operations. However, when a determination is made at query task 1326 that there are no more input fields 1310 associated with the loaded input row 1308, data conversion process 328 continues with a task 1338.

At task 1338, any remaining special input fields 1310 associated with the loaded input row 1308 may be processed.

Following task 1338, data conversion process 328 continues with a query task 1340. At query task 1340, a determination is made as to whether the input spreadsheet format of trade data 116 includes another one of input rows 1308. When there is another input row 1308, program control loops back to task 1306 to load the next one of rows 1308 and process it according to the previously described operations.

However, when a determination is made at query task 1340 that there are no more rows 1304, data conversion process continues with a task 1342. At task 1342, converted trade data 1318 is saved. It should be recalled that following data conversion during any of feed processes 314, 316, 318, 320, and 322 that converted trade data 1318, in the form of standardized trade records 202, is stored in failed trades database 114. Following task 1342, data conversion process 328 ends.

### FIG. 14

FIG. 14 shows a table 1400 of exemplary fields of trade data 116 in an XML format 1402 and converted trade data 1404 in a standardized format 1406 resulting from the execution of data conversion process 328. In this example, trade data 116 includes name fields 1408 and value fields 1410. Similarly, converted trade data 1404 includes name fields 1412 and value fields 1414.

Depending upon what data generator 118 is sending trade data 116 and how that trade data 116 is being communicated to failed trades reporting system 100, name fields 1408 can have different naming standards applied. Likewise, value fields 1410 can have different values applied. Execution of data conversion process 328 results in all trade data 116 from a plurality of data generators being arranged in standardized format 1406 for ready review and comparison.

### FIG. 15

FIG. 15 shows a flowchart of trade report generation process 330 executed in accordance with failed trades reporting system 100. The execution of trade report generation process 330 enables subscribing customers, i.e., data consumers 122, to view trade fail reports 120 from subscribing broker-dealers and custodians, i.e., data generators 118.

Trade report generation process 330 begins with a task 1500. At task 1500, data consumer 122 navigates to a log on web page. That is, the data consumer 122 accesses failed trades reporting system 100 via a website on the Internet. To maintain a high level of security, the website is only accessible via the HTTPS protocol. None of the web pages are accessible via the more common HTTP protocol. Data consumer 122 opens a web browser and points to a public URL to access the website for failed trades reporting system 100.

In response to task 1500, a task 1502 is executed to display the log on page at a user site.

Trade report generation process 330 continues with a task 1504. At task 1504, data consumer 122 enters credentials in the form of a user identifier and a password. A query task 1506 is performed in connection with task 1504. At query task 1506, system 100 determines whether the user identifier and password are valid. If a determination is made at query task 1506 that one or both of the user identifier and password are not valid, process control loops back to task 1502 to display the log on page, indicating that log on was prevented. However, when a determination is made at query task 1506 that the combination of the user identifier and password are valid, process 330 continues with a task 1508.

Once authenticated, at task 1508 the web server for failed trades reporting system 100 builds an encrypted token, called an FSTOKEN. FSTOKEN is built using an advanced encryption standards (AES) algorithm, such as Rijndael symmetric encryption, with data consumer identifier 206 being packaged into the encrypted token. FSTOKEN is an HTTP-ONLY cookie, meaning that it is valid only for the current browser session and it is not saved to disk on the user's web browser.

Next, a task 1510 is performed. At task 1510, the web server for system 100 builds a webpage for data consumer 122 in response to data consumer identifier 206. Then, a task 1512 is performed at which the webpage is sent to data consumer 122 with the encrypted token, i.e., FSTOKEN. That is, FSTOKEN is passed back as a cookie to the web browser used by data consumer 122.

Following task 1512, a task 1514 is executed. At task 1514, failed trades reporting system 100 receives request 332 from data consumer 122 for a particular webpage.

In response to task 1514, a query task 1516 is performed. At query task 1516, a determination is made as to whether request 332 is a request for a log out webpage. When request 332 is a request for a log out webpage, trade report generation process 330 proceeds to a task 1518. At task 1518, the encrypted token (FSTOKEN) is destroyed, indicating the end of the current browser session, and trade report generation process 330 ends. However, when request 332 is not a request for a log out webpage, process 330 continues with a query task 1520.

At query task 1520, a determination is made as to whether request 332 includes a valid encrypted token (FSTOKEN). When request 332 does not contain a valid encrypted token, program control returns to task 1502 at which the log on page is displayed. When request 332 contains a valid encrypted token, process 330 continues with a query task 1522.

Query task 1522 determines whether request 332 is a request for trade fail report 120. When request 332 is a request for trade fail report 120, program control proceeds with a task 1524. At task 1524, the web server for failed trades reporting system 100 generates a webpage with trade fail report 120 for provision to data consumer 122. The generation of trade fail report 120 may entail the compilation of a subset of trade records 202 sent by one of data generators 118 and designated by the log in data consumer 122, identified by data consumer identifier 206. Next, at a task 1526, failed trades reporting system 100 sends trade fail report 120 in a webpage with the encrypted token (FSTOKEN).

However, when a determination is made at query task 1522 that request 332 is not a request for trade fail report 120, program control proceeds with a task 1528. At task 1528, the web server for failed trades reporting system 100 generates the requested webpage for provision to data consumer 122. Next, at a task 1530, failed trades reporting system 100 sends trade fail report 120 in a webpage with the encrypted token (FSTOKEN).

Following either of tasks 1526 or 1530, program control loops back to task 1514 to await the receipt of another request 332. Accordingly, trade report generation process 330 continues until the user, i.e., data consumer 122 logs out and the encrypted token (FSTOKEN) is destroyed.

### FIG. 15

FIG. 16 shows a table 1600 of an exemplary trade fail report 120 generated in response to the execution of trade report generation process 330. As shown, trade fail report 120 includes data generator identifier 204, data consumer identifier 206, and a number of failed trade records 202, each of which is identified by a unique trade identifier 208. Each of failed trade records 202 further includes trade related data 210 in standardized format 1406. Trade related data 210 may be that presented in name fields 1412 and value fields 1414 of standardized format 1406, illustrated in FIG. 14. In an embodiment, data consumer 122 can only see failed trade records 202 that are designated by data generator 118 for viewing by data consumer 122.

In summary, the present invention teaches of a computer-based method and a failed trades reporting system that accepts trade data via a number of input mechanisms and in various formats. The computer-based method and a failed trades reporting system converts the received trade data into a standardized format for provision to subscribing customers, e.g., investment managers, broker-dealers, and custodians, in the form of failed trades reports. In an embodiment, an input mechanism entails a secure Internet-based hosted service that allows broker-dealers and custodians to report failed trades to investment managers through standard interfaces. Alternatively, broker-dealers and custodians can report failed trade data via SWIFT messaging, and spreadsheet entry.

Although the preferred embodiments of the invention have been illustrated and described in detail, it will be readily apparent to those skilled in the art that various modifications may be made therein without departing from the spirit of the invention or from the scope of the appended claims. For example, the process steps discussed herein can take on great number of variations and can be performed in a differing order then that which was presented.

What is claimed is:

1. A computer-based method for standardized reporting of failed trades comprising:
receiving trade data from a data generator, said receiving operation occurring at a computing system, said trade data including information characterizing at least one of said failed trades;
identifying a current format for said trade data, said current format being one of a plurality of recognizable formats;
selecting a conversion template for said current format;
converting said trade data into at least one failed trade record having a standardized format using said conversion template;
generating a trade fail report that includes said at least one failed trade record; and
providing said trade fail report to an authorized data consumer.

2. A computer-based method as claimed in claim 1 further comprising:
validating that said trade data includes said information characterizing said at least one of said failed trades; and
storing said trade data in a data queue following said validating operation, wherein said identifying, selecting, converting, generating, and providing operations are performed as a process distinct from said receiving operation by accessing said trade data stored in said data queue.

3. A computer-based method as claimed in claim 2 further comprising:
receiving second trade data from said data generator;
validating that said second trade data includes said information characterizing additional ones of said failed trades; and
storing said second trade data in said data queue following said validating said second trade data, wherein said identifying, selecting, converting, generating, and providing operations are performed on said second trade data as said process distinct from said receiving operation.

4. A computer-based method as claimed in claim 3 wherein each of said trade data and said second trade data includes a request identifier, said request identifier indicating that said trade data and said second trade data form a common batch of said failed trades from said data generator, and said validating operation validates a presence of said request identifier included with each of said trade data and said second trade data.

5. A computer-based method as claimed in claim 3 wherein said trade data is received from said data generator as a first data feed event at a first instant, and said second trade data is received from said data generator as a second data feed event at a second instant that differs from said first instant.

6. A computer-based method as claimed in claim 2 further comprising communicating an acknowledgement from said computing system to said data generator following said storing operation.

7. A computer-based method as claimed in claim 2 further comprising:
monitoring said data queue for said trade data;
when said trade data is available in said data queue, identifying said data generator associated with said trade data, wherein said data generator defines said current format for said trade data; and
said selecting operation further selects said conversion template from a plurality of conversion templates, said conversion template being adapted for said current format defined by said data generator.

8. A computer-based method as claimed in claim 1 wherein:
said receiving operation comprises receiving, at said computing system, said trade data from a plurality of data generators;
storing said trade data from said plurality of data generators in a data queue;
performing said identifying, selecting, converting, generating, and providing operations as a process distinct from said receiving operation by accessing said trade data from said plurality of data generators stored in said data queue.

9. A computer-based method as claimed in claim 1 wherein said current format for said trade data is an extensible markup language format, and said receiving operation occurs via a network connection between said data generator and said computing system.

10. A computer-based method as claimed in claim 1 further comprising:
obtaining said trade data from said data generator at a provider site prior to said receiving operation, said trade data being configured in accordance with a first format,
converting, at said provider site, said trade data from said first format to said current format; and
sending said trade data in said current format from said provider site for receipt at said computing system.

11. A computer-based method as claimed in claim 10 wherein:
said current format for said trade data is an extensible markup language format; and
said first format for said trade data is a Society for Worldwide Interbank Financial Telecommunication (SWIFT) message format.

12. A computer-based method as claimed in claim 1 wherein said current format for said trade data is an electronic spreadsheet format, and said receiving operation receives said trade data in said electronic spreadsheet format via one of a secure e-mail message, a file transport protocol (FTP) network connection, and manual entry by a data generator.

13. A computer-based method as claimed in claim 1 wherein:
said converting operation converts said trade data into a plurality of failed trade records, one each of said failed trade records being associated with one each of said failed trades; and
following said converting operation, storing said plurality of failed trade records in a failed trades database associated with said computing system.

14. A computer-based method as claimed in claim 13 further comprising:
receiving at said computing system a request for said trade fail report from said authorized data consumer; and
accessing said failed trades database to generate said trade fail report for provision to said authorized data consumer.

15. A computer-based method as claimed in claim 14 wherein said request includes a user identifier for said authorized data consumer, each of said trade records includes one of a plurality of user identifiers associated therewith, said user identifier being one of said plurality of user identifiers, and said accessing operation comprises identifying a subset of said trade records having said user identifier for said authorized data consumer associated therewith, said generating operation generating said trade fail report to include said subset of said trade records.

16. A computer-readable storage medium containing a computer program for providing standardized reporting of failed trades comprising:
a conversion template database including a plurality of conversion templates, each of said conversion templates being adapted for converting trade data from a current format to a standardized format, said current format being one of a plurality of recognizable formats including an extensible markup language format and an electronic spreadsheet format;
a failed trades database for storage of failed trade records; and
executable code for instructing a computing system to create a trade fail report that includes at least one of said failed trade records, said executable code instructing said computing system to perform operations comprising:
receiving trade data from a data generator, said trade data including information characterizing at least one of said failed trades;
identifying said current format for said trade data;
selecting one of said conversion templates from said conversion template database in response to said current format;
converting said trade data into said failed trade records having said standardized format using said selected one of said conversion templates, each of said failed trade records being associated with one each of said failed trades;
storing said failed trade records in said failed trades database;
accessing said failed trade records in said filed trades database to generate said trade fail report; and
providing said trade fail report to an authorized data consumer.

17. A computer-readable storage medium as claimed in claim 16 wherein said executable code instructs said computing system to receive said trade data in said extensible markup language format via a network connection.

18. A computer-readable storage medium as claimed in claim 16 wherein said executable code instructs said computing system to receive said trade data in said electronic spreadsheet format via one of a secure e-mail message, a file transport protocol (FTP) network connection, and manual entry by a data generator.

19. A computer-readable storage medium as claimed in claim 16 wherein each of said trade records includes one of a plurality of user identifiers associated therewith, and said executable code instructs said computing system to perform further operations comprising:
receiving a request for said trade fail report from said authorized data consumer, said request including one of said plurality of user identifiers; and
identifying a subset of said trade records in said failed trades database having said user identifier for said authorized data consumer associated therewith; and
generating said trade fail report to include said subset of said trade records.

20. A method performed by a computing system for standardized reporting of failed trades comprising:
performing a data feed process comprising:
receiving trade data from a data generator, said trade data including information characterizing at least one of said failed trades;
validating that said trade data includes said information characterizing said at least one of said failed trades; and
storing said trade data in a data queue following said validating operation; and
performing a trade reporting process distinct from said data feed process, said data reporting process comprising:
accessing said trade data stored in said data queue;
identifying a current format for said trade data, said current format being one of a plurality of recognizable formats;
selecting a conversion template for said current format;
converting said trade data into a plurality of failed trade records having a standardized format using said conversion template, one each of said failed trade records being associated with one each of said failed trades;
storing said plurality of failed trade records in a failed trades database associated with said computing system;
generating a trade fail report that includes said at least one of said failed trade records stored in said failed trades database; and
providing said trade fail report to an authorized data consumer.

21. A computer-based method as claimed in claim 20 wherein;
performing said data feed process further comprises:
receiving second trade data from said data generator, wherein said trade data is received from said data generator as a first data feed event at a first instant, and said second trade data is received from said data generator as a second data feed event at a second instant that differs from said first instant;
validating that said second trade data includes said information characterizing additional ones of said failed trades; and
storing said second trade data in said data queue following said validating said second trade data; and
performing said trade reporting process on said second trade data by accessing said second trade data in said data queue.

22. A computer-based method as claimed in claim 20 wherein performing said trade reporting process further comprises:
monitoring said data queue for said trade data;
when said trade data is available in said data queue, identifying said data generator associated with said trade data, wherein said data generator defines said current format for said trade data; and
said selecting operation further selects said conversion template from a plurality of conversion templates, said conversion template being adapted for said current format defined by said data generator.

23. A computer-based method as claimed in claim 20 wherein each of said trade records includes one of a plurality of user identifiers associated therewith, and performing said trade reporting process further comprises:
receiving a request for said trade fail report from said authorized data consumer, said request including one of said plurality of user identifiers;
identifying a subset of said trade records in said failed trades database having said user identifier for said authorized data consumer associated therewith, said generating operation generating said trade fail report to include said subset of said trade records.
